(19) United States
(12) Patent Application Publication
(10) Pub. No.: US 2016/0212558 A1
(43) Pub. Date: Jul. 21, 2016

(54) Multi-channel Wireless Microphone System

(71) Applicant: Sennheiser electronic GmbH & Co. KG, Wedemark (DE)

(72) Inventors: Klaus Willemsen, Wedermark (DE); Christian Politt, Wedemark (DE)

(73) Assignee: Sennheiser electronic GmbH & Co. KG, Wedemark (DE)

(21) Appl. No.: 14/950,039

(22) Filed: Nov. 24, 2015

(30) Foreign Application Priority Data
Nov. 24, 2014 (DE) 10 2014 223 883.8

(51) Int. Cl. H04R 29/00; H04R 3/00

(52) U.S. Cl. CPC H04R 29/007; H04R 3/005; H04R 29/005

(57) ABSTRACT

A multi-channel wireless microphone system. The wireless microphone system has a plurality of diversity antennas with a wide-band noise generator which can be switched on and a plurality of wireless receivers for wirelessly receiving the audio signals sent from a wireless microphone system. The noise generator is adapted to produce a wide-band noise signal for testing the wireless microphone system. The noise signal is received by the diversity antennas and output to the receivers. On the basis of the output signals of the receivers it is then possible to establish whether the cable arrangement between the diversity antennas and the receivers is in a fault-free condition.

The present application claims priority from German Priority Application No. 10 2014 223 883.8 filed on Nov. 24, 2014, the disclosure of which is incorporated herein by reference in its entirety

### FIELD OF THE INVENTION

The present invention concerns a multi-channel wireless microphone system.

A wireless microphone system typically has a plurality of wireless microphones and a plurality of wireless receivers for receiving the audio signals transmitted from the wireless microphones. The wireless microphones detect an audio signal for example of a singer and send the audio signal in the form of a wireless signal to an external wireless receiver. The wireless receivers can be connected for example to a mixer desk where for example a sound engineer can mix together the various audio signals from the respective wireless microphones to give an overall signal.

In the field of wireless stage microphones, there is a demand for multi-channel installations for example at concerts with a plurality of artists (with a band act) on the stage as each artist is provided with his or her own microphone. Because the artists nowadays generally want to move around freely on the stage there is typically a trend to use wireless (that is to say generally radio) transmission of the microphone signals. If a singer also plays a musical instrument two independent radio channels (voice and instrument) are generally used for that purpose. That makes it possible for the sound engineer to mix the volume of the instrument independently of the volume of the voice. In the case of groups which appear with a plurality of artists consequently numerous independent microphone channels come together. If the situation is one in which various groups change around on the stage during an event a corresponding number of “microphone groups” is also to be provided for that purpose. Thus, in fully typical events, a relatively large number of wireless microphone channels (microphone as transmitter and stationary receiver) come together. In the Eurovision Song Contest of 2013 there were for example 140 transmitting lines/channels. Those microphone channels are already programmed prior to the event and remain unchanged during the event in order to exclude sources of error.

Nowadays reception in the foregoing multi-channel wireless microphone systems is generally effected by so-called diversity receivers. They are so designed that, by way of two independent internal diversity paths, they receive the signals of two separate antennas and—depending on which respective antenna gives the better signal—use solely the high-frequency signal from that antenna for evaluation. The antenna signals in that case are also looped through the receivers, that is to say each receiver (except for the last one) receives the antenna signal byway of an input jack and transmits it to the next following receiver byway of an output jack. In the above installation byway of example with the 140 diversity receivers therefore a total of 280 cable connections are required for distribution of the high frequency signals of the two diversity antennas. In that case the intensities of the antenna signals of the receiving channels, which occur at the receiver inputs, are typically displayed on the operating panel of the receiver. In that way, they are visible to the sound engineer and allow a quick overview of the correct functioning of all individual radio channels. Nowadays the display of the signal strength is mostly effected by means of two bars/columns (a respective one for each diversity path) which fluctuate in size depending on the respective strength of the applied input signal and which upon a change in the current signal strength also change almost without delay (a so-called “bar graph display”). The 140 diversity receivers therefore display on two respective displays the strength of the 280 antenna signals at the inputs.

FIG. 1 shows a diagrammatic view of a microphone system according to the state of the art for a stage installation. FIG. 1 only shows the cabling of the diversity antennas 1a, 1b. The microphone systems shown in FIG. 1 use so-called diversity receivers, that is to say the receivers have two antennas la and lb and the output signal of that antenna which has the better signal is selected. Starting from the two diversity antennas 1a, 1b a cable arrangement of a receiving path passes through a receiving channel of the receivers 2, 3, 4—x. In addition a cabling arrangement of another receiving path is implemented through the second receiving channel of the same receivers. The bar graphs BG are only symbolically shown on the left-hand side. In addition it is necessary to ensure that the respective receiving path of the receiver is connected to the correct antenna (no transposition of the diversity paths) and that each receiver receives a sufficiently strong signal from each of the two antennas.

In the case of larger stages—or if shows take place on a plurality of stages (at the same time or with quick changes in respect of time)—the size of the area means that it is only rarely possible to manage with one pair of antennas. Then, a plurality of (at least two) pairs of antennas are required for each stage or for each region in which the shows are planned. If the antennas of a plurality of regions are to be switched on to the same receiver paths then so-called “antenna combiners” are used for that. The number of cable connections is accordingly further increased.

If (due to the cable lengths) the cable attenuation of the antenna signals should rise excessively greatly then the interposition of boosters is required. That additionally increases the number of cable connections. Greater cable lengths are required in particular if the spatial structure does not permit fitment of the antennas directly on or in the direct vicinity of the stage.

FIG. 2 shows a diagrammatic view of a multi-channel wireless microphone system according to the state of the art. The wireless microphone system has a plurality of diversity antennas 11a, 11b, 12a, 12b, 13a, 13b. Those diversity antennas receive audio signals wirelessly transmitted from the wireless microphones. The wireless microphone system further has a plurality of antenna combiners 14 which assemble the signals of the individual antennas. A respective booster 15 is provided between the antenna combiners 14 and a first receiver 16. The booster 15 serves to raise the level of the signals from the diversity antennas. In that way for example it is possible to compensate for losses due to long lines. Optionally, further boosters can be provided between the antennas and the antenna combiners when very long antenna lines are involved.

The output signals of the boosters 15 are then passed to the wireless receivers 16, 17, 18—y.

Testing processes and devices for cable arrangements and connections are available on the market in large numbers and with high complexity. The quality of the cable arrangements (= individual paths) can be measured with a very high degree of precision by many devices available on the market. However they all require a modification in the installation itself. Thus for example DE 103 05 741 A1 also provides a “method of testing at least one antenna”. Here too however manipulation of the installation itself is required and proper (=fault-free) restoration of the arrangement is thus not guaranteed.

In respect of the German patent application from which priority is claimed the German Patent and Trade Mark Office searched the following documents: DE 103 05 741 A1, DE 10 2005 038 077 A1 and WO 2005/064 828 A1.

### SUMMARY OF THE INVENTION

Thus an object of the present invention is to provide a simple way in which the various cable connections in a multi-channel wireless microphone system can be checked.

That object is attained by a multi-channel wireless microphone system as set forth in claim 1.

Thus there is provided a multi-channel wireless microphone system. The wireless microphone system has a plurality of diversity antennas each with a noise generator which can be switched on and a plurality of wireless receivers for wirelessly receiving the audio signals sent from a wireless microphone system. The noise generator is adapted to produce a wide-band noise signal for testing the wireless microphone system. The noise signal is received by the diversity antennas and output to the receivers. On the basis of the output signals of the receivers it is then possible to establish whether the cable arrangement between the diversity antennas and the receivers is in a fault-free condition.

According to an aspect of the present invention the noise generator is adapted to output a white noise over a wide frequency range. It can thus be ensured that the frequency range of all diversity antennas and all receivers is covered.

According to a further aspect of the present invention there is provided a noise generator in or on a housing of one of the diversity antennas. The noise generator can thus be easily integrated in or on the housing of the antenna so that it is constructed together with the antenna. That also makes it possible to be sure that fitment of the noise generator is not forgotten.

According to a further aspect of the present invention the noise generator can remotely controlled by way of a booster voltage from one of the receivers, can be activated by way of a remote control signal from a receiver or can be actuable by way of an encoded address.

According to a further aspect of the present invention there is provided an evaluation unit which evaluates the signals received by the receivers to check whether signals have been received from all diversity antennas. If that is the case then the cable arrangement is properly implemented. If that is not the case then the cable arrangement to those diversity antennas whose signal has not been received has to be checked.

The invention concerns the concept of providing a noise generator and activating same for checking the cable arrangement of the microphone system. Then the signals received from the diversity antennas are checked. Optionally the noise generator can be integrated in or on an antenna. The antenna and the noise generator can be for example in the form of one unit. Only the noise generator has to be activated for checking the cable connections of the wireless microphone system. That can be effected for example by actuating a switch. When the cable connections have been checked then the noise generator can be suitably switched off. Deactivation of the noise generator can be effected for example by cutting off the supply voltage.

According to an aspect of the present invention there is provided a multi-channel wireless microphone system comprising a plurality of antenna units which respectively have a test signal generator which can be switched on, and a plurality of wireless receivers for wirelessly receiving the audio signals received by way of the antenna unit and sent from a wireless microphone. The wireless microphone system further has a cable arrangement between the plurality of antenna units and the plurality of wireless receivers. The test signal generators are adapted to produce a test signal for checking the cable arrangement of the system (between the antenna units and the wireless receivers). The test signal is passed from the antenna units by way of the cable arrangement to the wireless receivers. It is thus possible in particular to check the cable arrangement between the antenna units and the wireless receivers of the wireless microphone system by means of the test signal.

The receivers can for example transmit a telegram to the connected antenna units. That telegram can contain for example the address of the antenna and a receiving frequency set at the receiver. According to an aspect of the present invention the test signal generator can send in response to that demand in the respective address antenna a narrow-band test signal on the frequency communicated to it. That is advantageous because a required attenuation or gain can thus also be communicated to the antenna units.

The aim of the invention is to provide a simple option which makes it possible for all those numerous cable connections in a multi-channel wireless microphone system to be checked quickly and at a low level of complication and expenditure (connection to the antenna, transposition by mistake of the two antennas of a pair of antennas, contact certainty, short-circuit, cable breakage, wrongly connected or unconnected cable paths, inadmissible cable attenuation). In that respect the aim is to establish whether all cable connections are completely connected to the respectively correct receiver paths, the two diversity paths of each receiver are correctly associated with the two associated diversity antennas and also that the cable attenuation effects are not too high, that is to say (if required) an adequate number of antenna boosters with a suitably set gain is disposed in the individual cable paths. That system is intended not to require any intervention in the installation itself (for example by cutting cable lines and looping in test devices) for in that case correct re-connection of the system after the test devices have been subsequently removed from the system would no longer be ensured as it is not possible to guarantee that those cable lines are also properly connected again (for example contact resistance of the connection and correct association). That argument may initially possibly sound rather trivial; however anyone who has himself witnessed the proceedings which go on behind large stages and the stress which is developed there during the set-up phase, in which some hundred meters of cable and some hundred plug connections just for properly operationally connecting the antennas together are easily involved, will be quickly able to understand this. It is precisely for that situation that a testing device is to be provided, which can ensure that the antennas are cable-connected to the receivers in the desired fashion as simply as possible and requiring very little additional time (and in particular without modifications in the installation itself and thus without the possibility of introducing fresh faults!). That is intended to permit checking of the cable arrangement without disconnecting the antenna lines.

Further configurations of the invention are subject-matter of the appendant claims.

Advantages and embodiments by way of example of the invention are described in greater detail hereinafter with reference to the drawing.

### BRIEF DESCRIPTION OF THE DRAWINGS

FIG. 1 shows a diagrammatic view of a multi-channel wireless microphone system according to the state of the art.

FIG. 2 shows a diagrammatic view of a multi-channel wireless microphone system according to the state of the art.

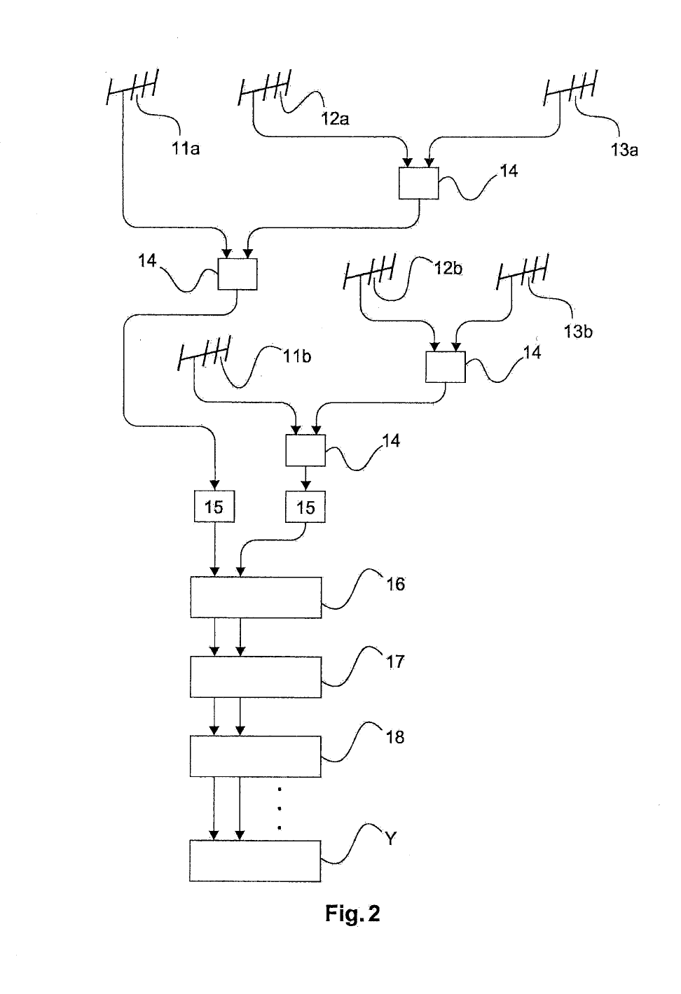

FIG. 3 shows a diagrammatic view of a multi-channel wireless microphone system according to a first embodiment of the invention.

FIG. 4 shows a diagrammatic view of a multi-channel wireless microphone system according to a second embodiment of the invention.

### DETAILED DESCRIPTION OF EMBODIMENTS

It is to be understood that the FIGS. and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

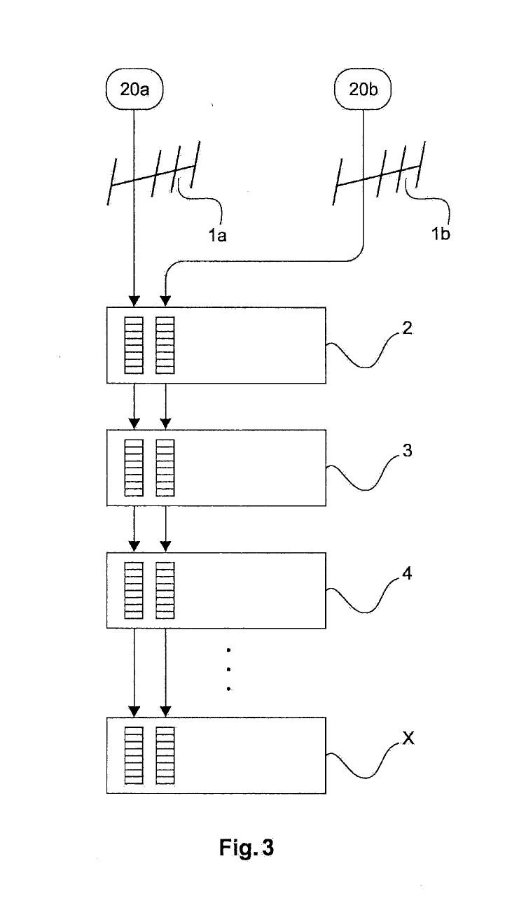

FIG. 3 shows a diagrammatic view of a multi-channel wireless microphone system according to a first embodiment of the invention. The wireless microphone system has a plurality of (diversity) antennas, 1a, 1b. Those (diversity) antennas, 1a, 1b receive audio signals transmitted from the wireless microphones. The wireless microphone system further has a plurality of receivers 2, 3, 4—x. According to the first embodiment of the invention a noise generator 20a, 20b is associated with each antenna 1a, 1b.

In the antennas the installed antenna amplifier (booster) is supplemented by an additional noise generator 20a, 20b. In the switched-on condition the noise generator optionally delivers a “white” noise, for example over the entire frequency range of interest (for example in the case of UHV installations of between 450 MHz and 900 MHz) which can be covered by the receivers. As a result all connected receivers display approximately the same level in the control display, irrespective of the frequency (channel) to which they are set. If in the entire installation only the noise generator of a single antenna is in operation, then on the basis of the control display on the receivers it is possible immediately to recognize which receivers are connected to that antenna and which are not. By switching over once (activation of the noise generator of the antenna of the other (diversity) path) it is thus possible in the case of dual-antenna diversity to check the cable arrangement of the entire installation without having to modify anything on the cable arrangement, irrespective of the number of receivers. In particular no cable line has to be disconnected. If all active control displays display approximately the same value (the level of the antenna signal therefore ranges within a desired “window”, that is to say it is neither too low nor too high) that also ensures that the cable attenuation is appropriately compensated. The advantage of this arrangement over a noise generator which is separately looped into the line is that the cable run—for which there is a wish to test precisely for correct functioning—does not have be interrupted for the test and thus there cannot be any fresh possibilities of faults being introduced in the entire cable arrangement.

By virtue of the low power of the noise generator 20a, 20b in operation the radiation emission byway of the antenna 1a, 1b itself into the environment can be practically disregarded. The signal can already be detected only with very great difficulty at a distance of about 2 meters. Therefore no inadmissible HF (high frequency or radio frequency RF) emission is produced, which would otherwise make HF-channels unusable for other transmissions at the same time. In the switched off condition in contrast naturally no power at all is emitted (that represents the operating condition of the installation after all cable connections have been tested).

If there were a wish to carry out the same functional test without the (wide-band) noise generator in the antenna line then it would be necessary to operate on a trial basis for each receiver a microphone tuned to its frequency—or another test transmitter tuned to that frequency—. As however in that case naturally both diversity paths then display a deflection on the display, the correct association of the two diversity paths on to the two receiving paths of the receiver is thus nonetheless still not guaranteed. In addition, as the radio microphones in fact only produce a narrow-band high-frequency signal, it would be necessary to carry out that test for each high-frequency channel in use (in the specified example, 140 times).

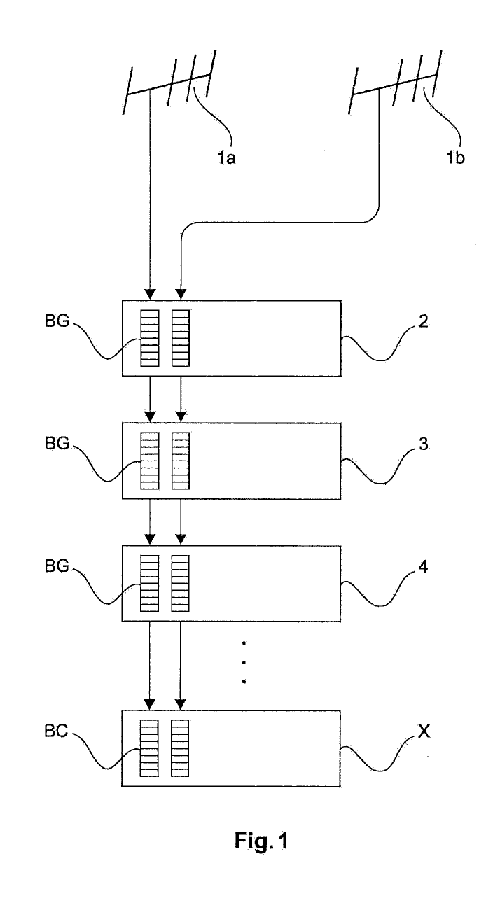

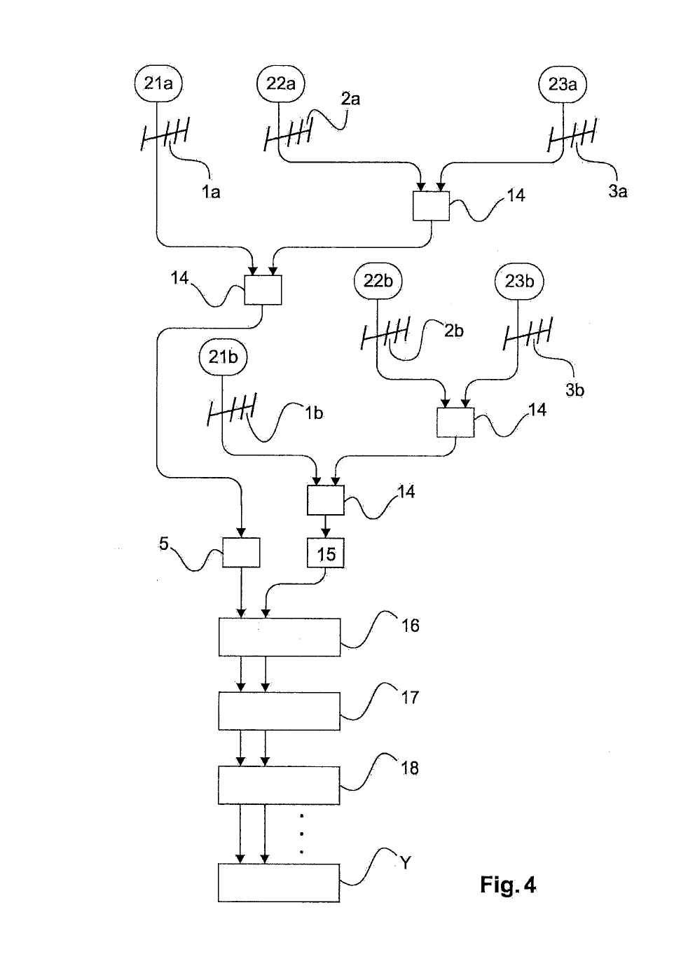

FIG. 3 shows once again the installation of FIG. 1, but this time with the expansion according to the invention. The two noise generators 20a and 20b fitted into the antennas can be switched on and off separately. The advantage of the invention can be quite quickly paid for even in a still relatively simple installation (as shown here); that is correspondingly more the case, the more extensive/more complicated that the overall installation is (for example as shown in FIG. 4).

If only the noise generator 20a is switched on then only the respective left-hand bar displays may also display an antenna signal. If in contrast only the noise generator 20b is switched on then only the right-hand bar displays of the receivers may display a corresponding signal.

FIG. 4 shows a diagrammatic view of a multi-channel wireless microphone system according to a second embodiment. The wireless microphone system has a plurality of (diversity) antennas or antenna units 11a, lib, 12a, 12b, 13a, 13b. Those (diversity) antennas receive audio signals wirelessly transmitted from the microphones. The wireless microphone system further has a plurality of antenna combiners 14 which combine the signals of the individual antennas. A respective booster 15 is provided between the antenna combiners 14 and a first receiver 16. The booster 15 serves to raise the level of the signals from the diversity antennas. In that way for example losses due to long lines can be compensated. Optionally, when involving very long antenna lines, it is possible to provide further boosters between the antennas and the antenna combiners; in contrast in the case of very short cable connections it may optionally also be possible to manage without additional boosters.

The output signals of the boosters 15 are then passed to the wireless receivers 16, 17, 18—y.

According to the invention the antennas 11a-13b can have installed antenna boosters and additionally a noise generator 21a-23b. The noise generators 21a-23b can deliver a white noise over the entire frequency range (for example in the case of UHF installations between 450 MHz and 900 MHz). The selected frequency range of the noise generators should be such that it covers the entire receiving frequency range of the receivers 16, 17, 18—y. The choice of a wide frequency range makes it possible to ensure that all receivers in the system have approximately the same level of the received antenna signals. If the noise generator of a diversity channel is activated then an operator can see for example by means of the control displays on the receivers, which receiver is connected to the activated antenna or not. Then the noise generators 21b-23b of the other diversity channel can be activated so that it is possible to check the cable arrangement of the entire system without having to modify anything on the cable arrangement.

If the controls of the respective receivers involve the same value it is then possible to be sure that the respective cable attenuation has been appropriately compensated.

According to the invention it is possible to test a wireless microphone system without in that case interfering in the cable arrangement. In that way it is also possible to ensure that no faults occur upon restoring the cabling configuration as no such restoration is required.

According to the invention at least one of the noise generators 21a-23b is activated to activate the test mode.

According to the invention the noise generator is provided in or at the respective antennas so that, because of the very low power of the noise generator, only a limited spatial radiation emission can occur. That is advantageous because this means that no inadmissible high-frequency radiation is generated, which could adversely affect adjacent high-frequency installations.

The noise generator 21a-23b can be remotely controlled by a booster voltage from one of the receivers. The noise generator can be activated by way of a remote control signal from the receiver. For that purpose an increased booster voltage or for example a 22 kHz pilot tone can be produced. Encoded addresses can be associated with the noise generators so that a noise generator can be switched on by the receiver on the basis of the encoded address. The encoded addresses can ensure that the noise generators of a plurality of antennas can be addressed separately.

The (diversity) antennas 11a-13b can have an antenna booster having a gain which can be switched over step-wise. The switch for switching over the gain of the antennas can have a further switch position for switching on the noise generator. The noise generator and the booster of the antenna can be in the form of an electrical component.

The noise generator can have a Zener diode (for example 5.7 volts) operated in the reverse direction. With an operating voltage of 12 volts that can provide an output voltage of between about 8 and 9 μV (microvolt). That output signal can be further boosted, for example by the factor of 10.

In accordance with an aspect of the invention instead of a noise generator it is possible to provide a test signal generator for producing a test signal. The test signal which in accordance with the first or the second embodiment was specified as a white (wide-band) noise can also be replaced by a narrow-band test signal. That is conceivable for example in the situations in which the (diversity) receivers are capable of sending relatively complex telegrams to the connected antennas. They then include for example not only the address of the antenna itself but also the receiving frequency set at the receiver.

In response to that demand a test signal generator in the respective addressed antenna can now send a narrow-band test signal at the frequency notified to it, for example by means of an oscillator. By virtue of an expansion of that test the required attenuation/gain necessary for compensating for the cable attenuation can also equally be set in the antenna. That can be effected by the receiver communicating the antenna byway of the telegram, the amount by which the gain has to be altered. In that way, by means of an automatic compensation process, the input voltage registered in the receiver can be kept at the desired level.

For microphone systems which operate in accordance with (synchronous) time multiplex processes the test signals from the antennas to the receivers can be such that they send their test signal precisely in the permissible/expected time segment. The correction value for the gain is then determined by the receiver, communicated to the antenna byway of the agreed telegram, and adjusted thereby.

For microphone systems which operate in accordance with a code multiplex process the test signals from the antennas to the receivers can be such that they address same by the output of the signal expected by the receiver. The correction value for the gain is then determined by the receiver, communicated to the antenna by way of the agreed telegram and adjusted thereby.

In accordance with an aspect of the invention the antennas or antenna units can also be in the form of non-diversity antennas.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A multi-channel wireless microphone system comprising:
a plurality of diversity antenna units each comprising:
a noise generator configured to be switched on; and
a plurality of wireless receivers configured to wirelessly receive audio signals sent from a wireless microphone and received by way of the diversity antenna units;
wherein each noise generator is adapted to produce a wide-band noise signal for testing the system; and
wherein the noise signal is received by the diversity antenna units and passed to the wireless receivers.

2. The multi-channel wireless microphone system as set forth in claim 1, further comprising:
at least one antenna combiner configured to combine output signals of various antenna units; and
a booster for boosting an output signal of the at least one antenna combiner.

3. The multi-channel wireless microphone system as set forth in claim 1;
wherein each noise generator is adapted to output a white noise over a wide frequency range.

4. The multi-channel wireless microphone system as set forth in claim 1;
wherein each noise generator is configured to be in or on a housing of one of the diversity antenna units.

5. The multi-channel wireless microphone system as set forth in claim 1;
wherein each noise generator is remotely fed by way of a booster voltage from one of the wireless receivers.

6. The multi-channel wireless microphone system as set forth in claim 1;
wherein each noise generator can be is configured to be activated by way of a remote control signal from one of the receivers; and
wherein the remote control signal represents an increased booster voltage or a pilot tone.

7. The multi-channel wireless microphone system as set forth in claim 1;
wherein an encoded address is associated with each of the noise generators; and
wherein each noise generator is actuable by way of the encoded address.

8. The multi-channel wireless microphone system as set forth in claim 1, further comprising:
an evaluation unit coupled to the wireless receivers, and configured to analyze the signals, received by the wireless receivers, of the respective diversity antenna units, to check whether signals have been received from each of the diversity antenna units during a test operation.

9. The multi-channel wireless microphone system as set forth in claim 1;
wherein the antenna units have antenna boosters which have a gain configured to be step-wise switched over; and
wherein on of the boosters is configured to switch on the noise generator.

10. The multi-channel wireless microphone system as set forth in claim 1;
wherein each noise generator is in the form of a Zener diode operated in the reverse direction.

11. A multi-channel wireless microphone system comprising:
a plurality of antenna units that each have a test signal generator configured to be switched on; and
a plurality of wireless receivers configured to wirelessly receive audio signals sent from a wireless microphone and received by way of the antenna units; and
a cable arrangement connecting the plurality of antenna units to the plurality of the wireless receivers;
wherein each test signal generator is adapted to produce a test signal for checking the cable arrangement of the system; and
wherein the test signal is passed from the antenna units by way of the cable arrangement to the wireless receivers.

12. The multi-channel wireless microphone system as set forth in claim 11;
wherein each test signal generator is configured to be in or on a housing of one of the antenna units.

13. The multi-channel wireless microphone system as set forth in claim 1;
wherein each test signal generator is remotely fed by way of a booster voltage from one of the wireless receivers.

14. The multi-channel wireless microphone system as set forth in claim 11;
wherein each test signal generator can is configured to be activated by way of a remote control signal from one of the receivers; and
wherein the remote control signal represents an increased booster voltage or a pilot tone.

15. The multi-channel wireless microphone system as set forth in claim 11;
wherein an encoded address is associated with each of the test signal generators; and
wherein each test signal generator is actuable by way of the encoded address.

16. The multi-channel wireless microphone system as set forth in claim 11, further comprising:
an evaluation unit coupled to the wireless receivers, and configured to analyze the signals, received by the wireless receivers, of the respective diversity antenna units, to check whether signals have been received from each of the antenna units during a test operation.

17. The multi-channel wireless microphone system as set forth in claim 11;
wherein the antenna units have antenna boosters which have a gain;
wherein the system further comprises a switch configured to step-wise switch over the gain; and
wherein the switch is further configured to switch on the noise generator.
